(19) United States
(12) Patent Application Publication
(10) Pub. No.: US 2022/0071263 A1
(43) Pub. Date: Mar. 10, 2022

(54) EDIBLE NUTRITION SYSTEM, METHOD OF PREPARATION AND USE THEREOF

(71) Applicant: Ulrich vom Bauer, Unterhaching (DE)

(72) Inventors: Ulrich vom Bauer, Unterhaching (DE); Andrea vom Bauer, Unterhaching (DE)

(21) Appl. No.: 17/481,630

(22) Filed: Sep. 22, 2021

Related U.S. Application Data
(63) Continuation of application No. 16/036,083, filed on Jul. 16, 2018, now abandoned.

(51) Int. Cl. A23P 10/30; A23L 29/256; A23L 29/212; A23P 20/25; A23L 29/281

(52) U.S. Cl. CPC A23P 10/30; A23L 29/256; A23V 2002/00; A23P 20/25; A23L 29/284; A23L 29/212

(57) ABSTRACT

The present invention relates to an edible composition, particularly an edible nutrition system, comprising an edible filling material (2) and an edible outer shell material (1), and the use thereof for the provision and/or transportation of edible materials. Additionally, in some embodiments, the edible nutrition system comprises an edible or potable substance (3). Further, the disclosure relates to a method for preparing said edible nutrition system.

### TECHNICAL FIELD

This disclosure relates to an edible composition, particularly an edible nutrition system, comprising an edible filling material and an edible outer shell material, and the use thereof for providing and/or transporting edible material. Further, the disclosure relates to a method for preparing such an edible nutrition system.

### BACKGROUND

For providing and/or transporting edible material, several various options are conceivable. However, generally always some kind of vessels, reservoirs or means for provision and/or transportation are necessary for putting or encapsulating the edible material in it before consumption by the costumer can take place. This is often, because the edible material has to be transported from its place of production to its place of consumption, which quite generally are not the same locations.

Said kind of vessels, reservoirs or means for providing and/or transporting the edible material however are generally not biodegradable and thus a burden for the environment. As the environmental consciousness is nowadays more and more present and plays a greater role, there is an unfulfilled need that such means for providing and/or transporting edible material are biodegradable and environmentally harmless.

Thus, on the one hand, it is the object of the present invention to use environmentally friendly and/or biodegradable material, which can be consumed with the edible material, and, at the same time, serves as a provision and/or transportation system for the edible material. Such biodegradable materials for providing and/or transporting food are often up to now either not available or not consumable, and mostly not at all nutritious or healthy for the consumer.

Further, another object besides an environmentally friendly material for provision and/or transportation of edible material is that the means for provision and/or transportation should guarantee a nutritious, at the same time healthy and an easy to handle and time-saving consumption of food. This is of great importance, for example, for business men and employees, which spend a large degree of their working time in meetings and who have not enough time to get a nutritious and healthy alternation for consuming food. They are often limited to the food provided in meetings or canteens. Thus, not only a nutritious and healthy alternative for consuming food, especially for the described group of consumers, is lacking, but also a way of consuming it time effectively under consideration of environmentally aspects.

While classical take-a-way food or fast food (such as burgers or french fries) or sandwiches consist of several ingredients (e.g. burger buns, the burger-meat, salad, cucumbers, burger sauce and spices such as mustard) there is hardly any fixed connection among such ingredients, making burgers sometimes hard to eat, especially without avoiding stains or smudges at shirts and business suits, mainly due to the fact that the edges of the burger or sandwiches remain open due to its layer structure.

Investigations of the food industry however confirm that the taste of sauce or sauce components is the main critical basis or mainstay for customer acceptance and success of a food composition in the market place. While storing e.g. sandwiches, these open edges lead to further disadvantages for the fillings, such as sausages or salad. Namely dry air and oxygen rapidly change the fillings—starting at the open edges of sandwiches to exert their influence.

Yet another disadvantage of sandwiches, burgers and the like where fillings are organized in layers are the interaction between different food components, for e.g. the sauce or dressings will be soaking into the bread making it fluffy and moist. For example, mayonnaise, mustard etc. can react to a taste disadvantage with the surrounding fillings and/or other food components. Other food, like french fries or chicken nuggets, is therefore served without sauce and customers are invited to add it later, yet making it almost impossible to have such kind of food on the go. Furthermore the sauce will need to be provided by the means of separate bags or sachets, creating additional disposables by one-way use.

Another disadvantage of today's food provisioning is the different appearance and method of preparation of various kinds of food offerings, serving as starter, main meal or dessert, making it impossible to use a standardized, lean and cost effective way of production ensuring economies of scale by its versatile use.

These disadvantages mentioned above are also not overcome by WO 2014/151326 A1, which describes an edible composition, comprising an edible substance and a cross-linked matrix.

However, the present disclosure fulfills these needs as it is described below.

### SUMMARY OF THE DISCLOSURE

The disclosure relates to an edible nutrition system, comprising

an edible filling material (2) and
an edible outer shell material (1),
wherein the edible outer shell material (1) encapsulates the edible filling material (2) completely or partially.

In some embodiments of the disclosure, in the edible nutrition system, the edible outer shell material (1) can be made of materials selected from the group consisting of dough, alginate, gelatin, starch, cellulose, proteins, egg white, xathan gum, guar gum, biopolymers, carrageenan gum, whey proteins, locust bean gum, soy bean, and combinations thereof.

Preferably, the edible outer shell material (1) is made of at least one layer of the materials selected from the group consisting of dough, alginate, gelatin, starch, cellulose, proteins, egg white, xathan gum, guar gum, biopolymers, carrageenan gum, whey proteins, locust bean gum, soy bean, nuts and combinations thereof.

More preferably, the edible outer shell material (1) is made of at least one layer of dough. This embodiment has the advantages that the edible nutrition system does not suffer from soaking or saturating, the reception of flavor is advantageous and novel combinations of food ingredients are possible by this structure of the outer shell material (1).

In some embodiments, the edible outer shell material (1) further comprises one or more additive(s), such as, but not limited to, color agents, spices, herbs, seeds, superfoods (such as baobab), salt, sugar, flour, parts or particles of plants such as, but not limited to, flowers, leaves, root fruits or fruit extracts, flavor agents, and combination thereof.

In some embodiments of the edible nutrition system of the disclosure, the edible filing material (2) is selected from the group consisting of fruit, meat, vegetable, a diary product, a carbohydrate food product, an energy supplement, a confection, a dietary supplement, a nutraceutical, a powdered vegetable, a flavoring agent, a sweetener, a powdered food product and combinations thereof.

In some embodiments of the edible nutrition system of the disclosure, the edible filing material (2) comprises edible particles, wherein the edible particles are selected from the group consisting of particles of a food, particles of a powdered vegetable, particles of a carbohydrate food, particles of an energy supplement, particles of a dietary supplement, particles of a confection, particles of a nutraceutical, particles of a flavoring agent, particles of a powdered food or particles of a sweetener.

In some embodiments of the edible nutrition system of the disclosure, the edible filling material (2) undergoes a reverse-spherification process.

In some embodiments, the edible nutrition system further comprises an edible or potable substance (3) additionally to the edible filling material (2) and the edible outer shell material (1).

This edible or potable substance (3) can comprise edible or potable particles, wherein the edible or potable particles are selected from the group consisting of particles of a food, particles or natural fibers of a vegetable or powdered vegetable, particles of an energy supplement, particles of a dietary supplement, particles of a confection, particles of a nutraceutical, particles of a flavoring agent, particles of vitamins, mineral sweets, particles of a sweetener, and combinations thereof.

Further, the edible or potable substance (3) can comprise ice cream, yeast, oil, gas like CO₂ or oxygen, chewing gum, caffeine, tea, coffee, cacao, milk or dairy products, such as but not limited to, yoghurt, curd, pudding, cottage cheese or butter milk.

In some embodiments of the edible nutrition system, the edible or potable substance (3) can be at least one of a powder, a gel, an emulsion, a fluid, a solid, and combinations thereof.

In some embodiments, the edible or potable substance (3) is selected from the group consisting of fruit, meat, vegetable, a diary product, an energy supplement, a confection, a nutraceutical, a powdered vegetable, a dietary supplement, a flavoring agent, a sweetener, and combinations thereof.

In some embodiments of the edible nutrition system, the edible or potable substance (3) can be a liquid. Preferably, said liquid comprises at least one of water, a juice, a soft drink, an alcohol, a sauce, a dressing, an energy supplement product, a dietary supplement, a confection, and combinations thereof. For example, the edible or potable substance (3) can be, but is not limited to, ketchup, mayonnaise, mustard, BBQ-sauce, sauce béarnaise, lemon liquid, lime liquid, strawberry liquid, a natural oil (like olive oil or fish oil) or taste enhanced oil (like garlic oil or basil oil), honey, marmalade, vanilla sauce or chocolate sauce.

Further, the disclosure refers to a method of preparing an edible nutrition system, comprising an edible filling material (2), an edible outer shell material (1) and optionally an edible or potable substance (3), comprising the steps of:
(a) optionally providing the edible or potable substance (3);
(b) providing the edible outer shell material (1) in the form of a bag;
(c) filling the edible filling material (2) in the bag of the edible outer shell material (1);
(d) optionally inserting the edible or potable substance (3) into the product of (c);
(e) closing the product of (d) with further edible outer shell material (1);
(f) placing the product of (e) into a baking form of desired shape;
(g) baking of the product of (f) in two baking steps.

### BRIEF DESCRIPTION OF THE DRAWINGS

FIG. 1 shows a schematically view of one embodiment of the edible nutrition system of the disclosure, comprising an edible or potable substance, identified with reference number (3), an edible filling material, identified with reference number (2), and an edible outer shell material, identified with reference number (1), wherein the edible or potable substance (3) is completely surrounded and/or encapsulated by the edible filling material (2) and wherein the edible filling material (2) is completely surrounded and/or encapsulated by the edible outer shell material (1).

FIG. 2 shows a schematically view of one embodiment of the edible nutrition system of the disclosure, comprising an edible or potable substance (3), an edible filling material (2) and an edible outer shell material (1), wherein more than one components of edible or potable substance (3) and more than one components of edible filling material (2) are mixed and are completely encapsulated by the edible outer shell material (1).

FIG. 3 shows a schematically view of another embodiment of the edible nutrition system of the disclosure, comprising an edible or potable substance (3), an edible filling material (2) and an edible outer shell material (1), wherein more than one components of edible or potable substance (3) are mixed in the edible filling material (2), which does not form one or more distinct components and both substances and materials (2) and (3) are completely encapsulated by the edible outer shell material (1).

FIG. 4 shows a schematically view of another embodiment of the edible nutrition system of the disclosure, comprising an edible filling material (2), which forms the total content of the edible nutrition system, wherein the edible outer shell material (1) completely encapsulates the edible filling material (2).

FIG. 5 shows a schematically view of another embodiment of the edible nutrition system of the disclosure, wherein more than one compartments of edible filling material (2) form the total content of the edible nutrition system, wherein the edible outer shell material (1) completely encapsulates the edible filling material (2) compartments.

FIG. 6 shows schematically the step (e) of the method of preparing the edible nutrition system as described herein.

### DETAILED DESCRIPTION OF THE INVENTION

The disclosure relates to an edible nutrition system, comprising

an edible filling material (2) and
an edible outer shell material (1),
wherein the edible outer shell material (1) encapsulates the edible filling material (2) completely or partially.

The term “completely encapsulated” as used herein means that about 100% of the edible filling material (2) is encapsulated or surrounded by the edible outer shell material (1).

The term “partially encapsulated” as used herein means in this connection that 5 to 99.99, preferably 20 to 99.9% and more preferably 30 to 99% of the edible filling material (2) is encapsulated or surrounded by the edible outer shell material (1).

In one embodiment of the edible nutrition system of the disclosure, the edible filling material (2) forms one or more components, preferably more than one component, in the edible nutrition system and wherein the edible outer shell material (1) connects these components of the edible filling material (2) with each other. The terms “to connect”, “connection” or “connecting” mean in this regard, that all edible filling materials (2) as described in this embodiment are so related with each other that only physical or shear forces can break up the connection between the various components. Preferably, in this embodiment, the one or more components of the edible filling material (2) is/are completely encapsulated as defined above by the edible outer shell material (1). Preferably, the one or more components of the edible filling material (2) comprise the same or various, more preferably various, edible materials and/or substances.

In a preferred embodiment, the edible nutrition system further comprises an edible or potable substance (3).

In one embodiment, the edible or potable substance (3) can form the innermost material or substance of the described edible nutrition system and is encapsulated, preferably completely encapsulated, by the edible filling material (2).

In another embodiment of the disclosure, the edible or potable substance (3) can form one or more, preferably more than one, components within the edible filling material (2) of the edible nutrition system, wherein the distribution of the edible or potable substance (3) in the edible filling material (2) is randomly. In a preferred embodiment of this embodiment, the more than one components of the edible or potable substance (3) are not connected with each other. In a more preferred embodiment of this embodiment, the more than one components of the edible or potable substance (3) are not connected with each other, are embedded in the edible filling material (2) and are completely encapsulated by the edible outer shell material (1). In a further preferred embodiment of this embodiment, the one or more components of the edible or potable substance (3) in the edible filling material (2) comprise the same or various substances or materials, more preferably various substances or materials. This has the advantage that novel combinations of food tastes can be created.

In the present disclosure, the edible nutrition system contains and protects edible substances, in order to achieve

a) one consistent food unit containing, keeping and protecting all required components during freezing, transporting, storing, unfreezing, provision to the consumer and eating;
b) unification or separation of ingredients that are required, but either need to remain connected or need to be separated since they impact each other in combination;
c) use of spherification process for creating a thermostable coating of the edible or potable substance (3), in order to avoid mixing with the edible filling material (2) or leaking out during a baking process and/or creating a thermostable coating of the edible filling material (2) in order to avoid mixing with the edible or potable substance (3) or leaking out during the baking process.

The use of spherification is one of the purposes of the present invention. Spherification is regularly used to provide an outer shell to liquids for decorative purposes for meal enhancement, or as food transport systems. Common practice is the usage at room temperature, as well as cooling down spherified bubbles for further processing. Spherification in the context of this disclosure is used:
to create a thermostable membrane to avoid leaking of liquids during the baking process; and
for creating a physical separator of ingredients, since after spherification they can be placed separately from other ingredients, either in various positions within the edible filling material (2) or the edible outer shell material (1).

All components of the edible nutrition system as described herein, namely the edible or potable substance (3), the edible filling material (2) and the edible outer shell material (1), build distinct arrangements of the components, however can vary in properties and conditions, which are necessary for fulfilling the above described objects. Thus, the described structure and composition of the distinct components building the edible nutrition system of the disclosure enables to provide advantageous and novel creations for food consumer.

Embodiments of the edible nutrition system described herein can have e.g. varying shell or membrane or material or shell material or substance thickness, one or more of a variety of chemical constituents, varying numbers of membranes, various consumable payloads, various shapes, and are construed from various shell/membrane/material/shell material properties to provide a variety of flavors and textures and material characteristics. The terms “membrane”, “material”, “shell”, “shell material” or “substance” can be used interchangeable herein.

The various embodiments of the edible nutrition system as described herein can further comprise one or more fillings in clearly distinguishable components or sections. It is also possible that the one or more fillings in the edible nutrition system of the disclosure are homogenously mixed. The various embodiments of the edible nutrition system as described herein can further contain one or more edible or potable substances (3) in one or more separate components, while the separated components are created by the process of spherification.

Spherification describes a process of creating spheres of liquid surrounded by a thin jelly membrane. This is achieved by adding sodium alginates into a liquid (e.g., apple juice), then dropping the preparation in a calcium bath (calcium lactate or calcium chloride). Beyond their biocompatibility to human use, polymers such as alginate have the capacity to easily form a gel. Depending on the ingredients and the desired strength of the jelly membrane, also a process called reverse-spherification can be used. Here calcium lactate or calcium chloride is added to the juice or sauce and the preparations are dropped in an alginate bath. The advantage of reverse spherification is that jellification can be tighter controlled, since removal from the alginate bath will stop the jellification process. Furthermore usage of reverse spherification is advantageous if the intended liquid contains a certain amount of intrinsic chlorides already. In this case, by adding alginate, the jellification process would already start without any further dropping into a chloride bath. The process starts already at chloride concentrations found in tap water. In this context spherification is used for both reverse and regular spherification unless explicitly stated.

Alginates have been applied to pharmaceutical preparations, impression-making materials (e.g., in dentistry and in prosthetics manufacturing), and in the food industry.

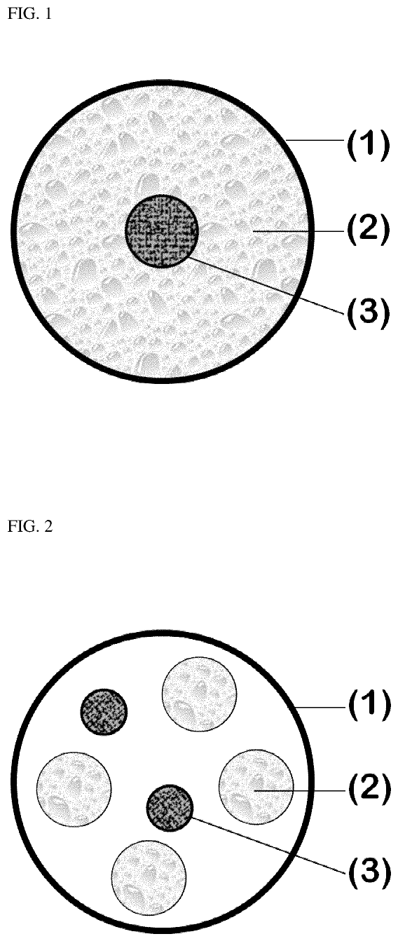

Preferably, the edible nutrition system of the disclosure has a structure as depicted in FIG. 1, wherein the edible or potable substance (3) builds the innermost material or substance, while the edible filling material (2) is the second innermost material and the edible outer shell material (1) is the utmost material. Thus, in some preferred embodiments, the edible filing material (2) completely surrounds or encapsulates the edible or potable substance (3). Further, in some preferred embodiments, the edible outer shell material (1) completely surrounds or encapsulates the edible filling material (2).

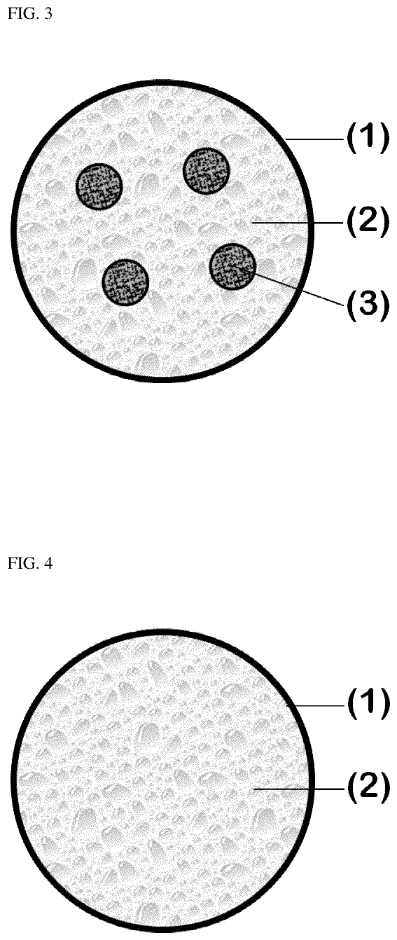

In an also preferred embodiment, the edible nutrition system of the disclosure has a structure as depicted in FIG. 2, wherein more than one components of edible or potable substance (3) and more than one components of edible filling material (2) are mixed and are completely encapsulated by the edible outer shell material (1). In an also preferred embodiment, the edible nutrition system of the disclosure has a structure as depicted in FIG. 3, wherein more than one components of edible or potable substance (3) are mixed in the edible filling material (2) and both substances and materials (2) and (3) are completely encapsulated by the edible outer shell material (1).

In an also preferred embodiment, the edible nutrition system of the disclosure has a structure as depicted in FIG. 4, wherein edible filling material (2) forms the total content of the edible nutrition system, wherein the edible outer shell material (1) completely encapsulates the edible filling material (2).

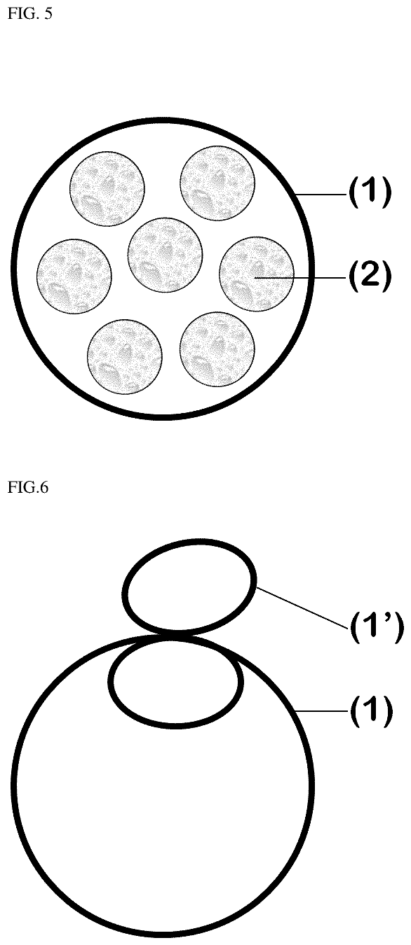

In an also preferred embodiment, the edible nutrition system of the disclosure has a structure as depicted in FIG. 5, wherein more than one compartments of edible filling material (2) form the total content of the edible nutrition system, wherein the edible outer shell material (1) completely encapsulates the edible filling material (2) compartments.

“Edible” materials as used herein are generally solid, semi-solid or liquid in form, are capable of providing nutrition when consumed, and are typically provided in a form suitable for digestion. Edible materials can be derived from many sources, including plants and animals, particularly those generated by agriculture, or from artificial production methods including chemical synthesis. Edible refers to any substances that can provide for an organism, e.g. a human or other mammal, nutritional needs or sensory desires, typically, when consumed orally and is usually non-toxic when properly consumed.

In some embodiments, in the edible nutrition system, the edible outer shell material (1) can be made of materials selected from the group consisting of dough, alginate, gelatin, starch, cellulose, proteins, egg white, xathan gum, guar gum, biopolymers, carrageenan gum, whey proteins, locust bean gum, soy bean, nuts and combinations thereof.

The term “dough” means in this context any kind of dough, such as, but not limited to, dough made from corn (maize), rice, wheat, barley, sorghum, millet, oat, rye, amaranth, soybean flour, a mix of cereals or any kind of breadcrumbs, and combinations thereof.

The term “alginate” as used herein can be, for example, but is not limited to, sodium alginate, ammonium alginate, potassium alginate, and propylene glycol alginate.

The term “protein” as used herein can be used, for example, for any biomolecule or macromolecule composed of one or more long chains of amino acid residues. Proteins are assembled from amino acids by using the information encoded in the genes. The amino acid sequence builds the primary structure of the protein. This sequence of amino acids but also the secondary, tertiary and quaternary structures of the protein are essential since they determine the structure and function of a protein. Due to this, a protein has several functions. It may serve as a structural protein (e.g. keratin), as enzymes, as transporters (e.g. hemoglobin), as antibodies, or as regulators of gene expression. A protein may be classified based on its form and main functions: It can be a globular protein, like most enzymes, a fibrous protein, which plays a structural role; and a membrane protein that serves as receptor or channel for polar or charged molecules to pass through the cell membrane.

Preferably, the edible outer shell material (1) is made of at least one layer of materials as defined above for the edible outer shell material (1).

More preferably, the edible outer shell material (1) is made of at least one layer of dough as defined above. This embodiment has the advantages that the edible nutrition system does not suffer from soaking or saturating, the reception of flavor is advantageous and novel combinations of food ingredients are possible.

The edible outer shell material (1) forms and stabilizes the edible nutrition system so that one consistent food unit is build, containing, keeping and protecting all required components disclosed therein during the product life cycle, including, but not limiting to, freezing, transporting, storing, unfreezing, provision to the consumer and eating. A seamless edible outer shell material (1) provides protection against drying out and reduces the influence of oxygen contained in the air of the encapsulated ingredients.

In some embodiments of the disclosure, the edible nutrition system is sphere-shaped, egg-shaped or bubble-shaped, for convenient eating experience. However, also any sort of roll, bobbing, prismatic or box shape as well as any customized shape is formable by the means of choosing the appropriate structure of the edible outer shell material (1) during production or formatting the edible nutrition system into the desired shape. The formatting process preferably could be carried out at the place of production before deep freezing for dispatch to customers, but could be done also after unfreezing the product at the place of eating in combination or separate to the heating process, while conditioning the product for consumption.

Preferably, the edible nutrition system of the disclosure has a diameter in the range of about 0.5 cm to about 20 cm, preferably in the range of about 1 cm to about 10 cm, more preferably in the range of about 2 cm to about 5 cm. When the edible nutrition system is egg-shaped the term “diameter” as used herein defines the diameter along the longest axis of the egg-shaped edible nutrition system.

In some embodiments of the disclosure, the edible nutrition system as described herein comprising the edible outer shell material (1) and the edible filling material (2) or comprising the edible or potable substance (3), the edible filling material (2) and the edible outer shell material (1) retains its shape, color, taste, and internal composition for a period in the range from several hours to 1 day, 1 day to 3 days, 3 days to 1 week, 1 week to 2 weeks, 2 weeks to 1 month, 1 month to 3 months, 3 months to 6 months, 6 months to 1 year or over 1 year.

In some embodiments of the disclosure, the edible outer shell material (1) or membrane has a thickness in the range of about 0.5 mm to about 20 mm, preferably in the range of about 1 mm to about 10 mm, more preferably in the range of about 2 mm to about 5 mm. The term “thickness” of the edible outer shell material (1) here means the thickness, which is formed by the membrane- or shell-like shape of the edible outer shell material (1) around the edible filing material (2) or the edible filing material (2) and the edible or potable substance (3).

The decision about the concrete thickness of the edible outer shell material (1) depends on the kind of the edible outer shell material (1), preferably the type of dough, as well as the specific applied baking procedure. In some embodiments of the disclosure, the edible outer shell material (1) may also be used to encapsulate or surround the edible filling material (2) or the edible or potable substance (3) or both of them completely or partially as defined above, in order to further strengthen the structure of the edible nutrition system.

Mentioned ranges of thicknesses have the advantage that the edible outer shell material (1) and the edible nutrition system in general remain stable over a very long term of storage. At the same time the respective flavor is maintained, as it is protected by the chosen edible outer shell material (1).

In some embodiments of the disclosure, the edible filling material (2) or membrane has a thickness in the range of about 2 mm to about 200 mm, preferably in the range of about 5 mm to about 100 mm, more preferably in the range of about 10 mm to about 20 mm. The term “thickness” of the edible filling material (2) here means the thickness, which is formed by the membrane- or shell-like shape of the edible filling material (2).

In some embodiments of the edible nutrition system of the disclosure, the edible filling material (2) is a homogenous mix of its ingredients.

In some embodiments of the disclosure, the edible filling material (2) is an un-homogenous mix of its ingredients, for the purpose of providing better durability or simpler production steps or new taste experiences.

In some embodiments of the disclosure, the edible filling material (2) is separated into one or more compartments. These one or more compartments can comprise the same or various edible materials.

The edible filling material (2) can be separated by means of spherification either as a whole from the edible outer shell material (1) as well as from the edible or potable substance (3), but also in a way that separates any of its one or more compartments from the other by encapsulating any ingredient or mix of ingredients disclosed therein by a spherification process.

In some embodiments of the disclosure, the edible or potable substance (3) is sphere-shaped, egg-shaped or bubble-shaped. In some embodiments of the disclosure, the edible or potable substance (3) has a diameter in the range of about 1 mm to about 30 mm, preferably in the range of about 1.5 mm to about 15 mm, more preferably in the range of about 2 mm to about 10 mm. More preferably, the edible or potable substance (3) is sphere-shaped, egg-shaped or bubble-shaped and has a diameter in the range of about 1 mm to about 30 mm, preferably in the range of about 1.5 mm to about 15 mm, more preferably in the range of about 2 mm to about 10 mm. When the edible or potable substance (3) is egg-shaped, the term “diameter” as used herein defines the diameter along the longest axis of the egg-shaped edible or potable substance (3).

In some embodiments the edible outer shell material (1) further comprises one or more additive(s), such as, but not limited to, color agents, spices, herbs, seeds, superfoods (such as baobab), salt, sugar, flour, parts or particles of plants such as, but not limited to, flowers, leaves, root fruits or fruit extracts, flavor agents, and combinations thereof.

Flavor agents as used in the whole disclosure can be, but are not limited to, fruit or vegetable flavor, any artificial flavor, to elicit a desired taste perception (sweet, sour, bitty, salty and/or umami, and associated food or flavoring, e.g. mint, taste), as well as herbal or plant flavors that can otherwise be considered non-food (e.g., cinnamon), such as coffee, chocolate, and other confectionary flavors.

Color agents as used herein in the whole disclosure can be for example, but are not limited to, carotenoids, chlorophyllins, anthocyanins or betanins.

The addition of a color agent has the advantage that the flavor of the edible nutrition system can be identified for the consumer by the color of the edible outer shell material (1) due to the addition of this color agent. The consumer is e.g. thereby able to draw conclusions from the color of the edible outer shell material (1) to the edible material contained inside. For example an edible nutrition system, which tastes like carrot, can receive a carrot-like color for the edible outer shell material (1).

Also the addition of a flavor agent to the edible outer shell material (1) can have the advantage that conclusions about the filling material (2) or the edible or potable substance (3) by the consumer can be drawn.

Certain embodiments of the present invention include, but are not limited to, that the edible outer shell material (1) comprises on its surface particles selected from the group consisting of seeds, such as sesame or chia; mustard, nuts such as, but not limited to, walnut or hazelnut; spices such as, but not limited to, salt or pepper; crumbles, onions and sprinkles, breadcrumbs, glazing, icing, frosting, sugar and sweetener, chocolate, vanilla, fruit particles such as, but not limited to, raisins or plum; cheese and dairy products; meat, such as, but not limited to, bacon or sausages; egg or egg white; flour; alginates; and combinations thereof. With these particles on the edible outer shell material (1) the edible nutrition system remains crispy and tasty, so that the edible nutrition system is easy to handle for the customer. Additionally, the customer remains clean hands and no waste is produced.

In some embodiments, the edible or potable substance (3) comprises edible or potable particles, wherein the edible or potable particles are selected from the group consisting of particles of a food, particles or natural fibers of a vegetable or powdered vegetable, particles of an energy supplement, particles of a dietary supplement, particles of a confection, particles of a nutraceutical, particles of a flavoring agent, particles of vitamins, mineral sweets, ice cream, yeast, oil, gas like CO₂ or oxygen, chewing gum, caffeine, tea, coffee, cacao, milk or dairy products, such as, but not limited to, yoghurt, curd, pudding, cottage cheese or butter milk; and particles of a sweetener.

Dietary supplements as used herein can be, but are not limited to, ascorbic acid (vitamin C), B vitamins, biotin, fat soluble vitamins, folic acid, HCA (hydroxycitric acid), inositol, pyruvate, mineral ascorbates, mixed tocopherols, niacin (vitamin B3), orotic acid, PABA (para-aminobenzoic acid), pantothenates, pantothenic acid (vitamin B5), pyridoxine hydrochloride (vitamin B6), riboflavin (vitamin B2), synthetic vitamins, thiamine (vitamin B1), tocotrienols, vitamin A, vitamin D, vitamin E, vitamin F, vitamin K, vitamin oils, vitamin premixes, vitamin-mineral premixes, water soluble vitamins, arsenic, boron, calcium, chloride, chromium, cobalt, copper, fluorine, iodine, iron, magnesium, manganese, molybdenum, nickel, phosphorous, potassium, selenium, silicon, sodium, strontium, sulfur, vanadium, zinc, and combinations thereof.

Energy supplements as used herein can be, but are not limited to, american ginseng, red ginseng, siberian ginseng, maca, rhodiola, ginger, guarana, turmeric, acetyl-L-carnitine, L-carnitine, creatine, taurine, L-phenylalanine, L-arginine, tyrosine, acetyl-tyrosine, N-acetyl L-tyrosine, ginko biloba, yerba-mate, kola nut, gotu kola, maitake, cordyceps sinensis, guarana, acai-berry, L-theanine, caffeine, quercitine, synephrine, green tea extract, theophylline, epigallocatechin gallate (EGCG), capsaicin, bee pollen, alpha-lipoic acid, and 1,3 dimethylamylamine (geranium), D-ribose, Fo-Ti, cha de bugre extract, St. Johns worth, and combinations thereof.

In some embodiments, said edible particles of the edible or potable substance (3) comprise a stabilizer, hydrocolloid, shellac, fibers, bagasse, baobab, tapioca, chitosan, sugar derivatives, chocolate, seaweed, and combinations thereof.

In a preferred embodiment, the edible particles comprised in the edible or portable substance (3) are a stabilizer.

Stabilizers for use herein include, but are not limited to, acids, acidifiers, antibleaching agents, antibrowning agents, anticaking agents, antimicrobial agents, antioxidants, antioxidant synergists, antisticking agents, binders, bleaching agents, bodying agents, buffers, bulking agents, carbonating agents, carrier solvents, clarifying agents, cloud producing agents, colloidal stabilizers, color fixatives, color stabilizers, coloring agents, defoaming agents, disintegrating agents, dispersing agents, dough conditioners, drying agents, emulsifiers, enzyme activators, extraction solvents, fillers, film formers, filter aids, firming agents, flavor enhancers, flavoring adjuncts, flavoring agents, flour-treatment agents, foaming agents, free-flow agents, freezants, glazes, gelling agents, general purpose additives, humectants, intensifiers, leavening agents, lubricants, maturing agents, moisture-retaining agents, neutralizing agents, oxidizing agents, packing gases, pH control agents, plasticizers, polishes, preservatives, propellants, sequestrants, solubilizers, stabilizers, starch-modifying agents, surface-active agents, surface-finishing agents, suspending agents, sweetening agents, synergists, texture-modifying agents, texturizers, thickeners, wetting agents, whipping agents, and derivatives and combinations thereof.

In some embodiments of the edible nutrition system, the edible or potable substance (3) can be at least one of a powder, a gel, an emulsion, a solid, a fluid and combinations thereof.

In some embodiments, the edible or potable substance (3) is selected from the group consisting of fruit, meat, vegetable, nuts, a diary product, an energy supplement, a confection, a nutraceutical, a powdered vegetable, a flavoring agent, a sweetener, a gas like CO₂ or oxygen, and combinations thereof.

In some embodiments of the edible nutrition system, the edible or potable substance (3) can be a liquid.

Preferably, said liquid comprises at least one of water, a juice, an alcohol, a soft drink, a tea product, a coffee product, a cacao product, a diary product, a sauce, a dressing, an energy supplement product, a dietary supplement, a confection, and combinations thereof. For example, the edible or potable substance (3) can be, but is not limited to, ketchup, mayonnaise, mustard, BBQ-sauce, sauce béarnaise, lemon liquid, lime liquid, strawberry liquid, a natural oil (like olive oil or fish oil) or taste enhanced oil (like garlic oil, basil oil), honey, marmalade, vanilla sauce or chocolate sauce.

In some embodiments of the edible nutrition system of the disclosure, the edible or potable substance (3) undergoes a reverse-spherification process.

In some embodiments of the edible nutrition system, the edible filing material (2) is selected from the group consisting of fruit, meat, vegetable, a diary product, a carbohydrate food product, an energy supplement, a confection, a dietary supplement, a nutraceutical, a powdered vegetable, a flavoring agent, a sweetener, a powdered food product and combinations thereof.

In some embodiments of the edible nutrition system, the edible filing material (2) comprises edible particles, wherein the edible particles are selected from the group consisting of particles of a food, particles of a powdered vegetable, particles of a carbohydrate food, particles of an energy supplement, particles of a dietary supplement, particles of a confection, particles of a nutraceutical, particles of a flavoring agent, particles of a powdered food or particles of a sweetener.

In some embodiments of the edible nutrition system of the disclosure, the edible filling material (2) undergoes a reverse-spherification process.

Advantages of the edible nutrition system of the disclosure:

The edible nutrition system of the disclosure prevents leaking of liquid(s) out of the edible nutrition system during a baking process of the edible nutrition system by the means of spherification or reverse spherification.

The edible nutrition system of the disclosure ensures a physical separation by means of placement or membrane building. Thus, the structure of the edible nutrition system described herein contributes to a better taste and or longer life period of the product. Further, the edible nutrition system has a constitution and/or structure that contribute to a simpler, faster and energy-saving production process and a large amount and variation of various tastes. It can serve as a starter, main meal or dessert. Additionally, the edible nutrition system of the disclosure ensures an easy and clean eating experience due to its structure and constitution described herein.

Further, the disclosure refers to a method of preparing an edible nutrition system, comprising an edible filling material (2), an edible outer shell material (1) and optionally an edible or potable substance (3), comprising the steps of:

(a) optionally providing the edible or potable substance (3);

(b) providing the edible outer shell material (1) in the form of a bag;

(c) filling the edible filling material (2) in the bag of the edible outer shell material (1);

(d) optionally inserting the edible or potable substance (3) into the product of (c);

(e) closing the product of (d) with further edible outer shell material (1);

(f) placing the product of (e) into a baking form of desired shape;

(g) baking of the product of (f) in two baking steps.

The term “bag” as used in the method of preparing an edible nutrition system as described herein, means any conceivable kind of bag, sachet, pocket, hollow, sphere or bulge of the edible outer shell material (1), which is able to receive the required or appropriate amount of edible filling material (2) or the edible filling material (2) and the edible or potable substance (3).

The method of preparing an edible nutrition system as described herein is especially advantageous, because it ensures the establishment of a stable nutrition system, which keeps its form, taste or ingredients until it is consumed.

In a preferred embodiment of the method of preparing an edible nutrition system as described herein, in step (a) the edible or potable substance (3) is provided in the form of one compartment, preferably after a spherification process, either at room temperature or in a frozen condition. This has the advantage that the filling of the edible or potable substance into the edible nutrition system is especially good manageable.

In another preferred embodiment of the method of preparing an edible nutrition system as described herein, in step (a) one or more compartments of the edible or potable substance (3), preferably after an spherification process, is/are provided and the method further comprises mixing the one or more compartments of the edible or potable substance (3) with the edible filling material (2) before step (c) and the product thereof is inserted in the bag of outer shell material (1). This means that not only the edible filling material (2) is filled into the bag of edible outer shell material (1) in step (c) of the method, but the mixture of one or more compartments of edible or potable substance (3) and the edible filling material (2). The optional step (d) is thus not required in this embodiment of the method of preparing an edible nutrition system as described herein.

In another preferred embodiment of the method of preparing an edible nutrition system as described herein, additionally one or more compartments of the edible filling material (2), preferably after an spherification process, are provided and the one or more compartments of the edible filling material (2) and the one or more compartments of the edible or potable substance (3) of step (a) are inserted into the bag of edible outer shell material (1) before step (e).

In some embodiments of the method of preparing an edible nutrition system as described herein, the edible or potable substance (3) is provided in a sphere-, egg- or bubble-shape. These shapes are particularly advantageous for inserting the edible or potable substance (3) into the product of (c) in step (d) of the method described herein.

In some embodiments of the method of preparing an edible nutrition system as described herein, the compartments made of either the edible filling material (2) or the edible or potable substance (3) or the combination of both can be deep frozen before inserting, in order to give greater strength to the compartments during the production process.

In the method of preparing an edible nutrition system as described herein, the edible outer shell material (1) is provided in the form of a bag for providing a hollow form of the edible outer shell material (1), which is able to include the edible filling material (2) and optionally the edible or potable substance (3) in steps (c) and (d) of the method of preparing an edible nutrition system as described herein.

In the method of preparing an edible nutrition system, as described herein, the outer shell material (1) is provided as a bag or sphere as defined above, with a small hole or opening typically ⅓- 1/10 of the diameter of the edible outer shell material (1), for the filling process, which is carried out in steps (c) and (d) of the method described herein. The hole or opening is closed after the filling process in steps (c) and (d) with further, but the same type of edible outer shell material (1′) as provided in step (b) of the method.

In some embodiments of the method of preparing an edible nutrition system as described herein, the edible nutrition system of the disclosure is produced by baking in the oven. In some embodiments of the method of preparing an edible nutrition system the two baking steps of step (g) are carried out consecutively. In some embodiments of the method of preparing an edible nutrition system, the two baking steps of step (g) are carried out separately. This means that in some embodiments, the two baking steps of step (g) of the method of preparing an edible nutrition system of the disclosure are two separate baking steps. Those can be carried out temporal and/or local separately. At least one first baking step is carried out to mold the ingredients of the product and to ensure proper conservation. Time and temperature of the baking procedure are derived from recipe and ingredients of the product.

In some embodiments of the method of preparing an edible nutrition system as described herein, the edible nutrition system is produced by baking in step (g) in a first baking step in the oven. Subsequently, the edible nutrition system received by this first baking step of step (g) is frozen and transported e.g. to the place of consumption or to the place of storage of the edible nutrition system. The described freezing step has no importance for preparing the edible nutrition system, but is exclusively carried out for storage or transportation of the edible nutrition system. Said product of the first baking step of step (g) is thawed, e.g. at the place intended for consumption, and the second baking step of step (g) is carried out, e.g. also by baking in a baking oven.

The two separate baking steps of step (g) have the advantage that at the place of consumption not the whole baking time has to be carried out. This is time & energy-saving for the seller of the product and enables him to provide fast food for customers in rush. On the other hands, the product after the first baking step of step (g) is especially appropriate for storage or transportation.

Preferably, the first baking step of step (g) of the method of preparing an edible nutrition system as described herein, takes 50 to 100% of the total required baking time, more preferably 60 to 90% of the total required baking time and most preferably 70 to 80% of the total required baking time.

Preferably, the second baking step of step (g) of the method of preparing an edible nutrition system as described herein, takes 0 to 50% of the total required baking time, more preferably 10 to 40% of the total required baking time and most preferably 20 to 30% of the total required baking time.

Preferably, the first and the second baking steps of step (g) of the method of preparing an edible nutrition system as described herein, are each carried out at a temperature in the range of 100 to 250° C., more preferably in the range of 150 to 230° C. and more preferably in the range of 170 to 200° C. in a baking oven.

All embodiments mentioned above in connection with the edible nutrition system are also disclosed herein in connection with the described method of preparing the edible nutrition system and reverse.

The present invention further discloses the use of the edible nutrition system as described herein for providing and/or transporting food material.

One having ordinary skill in the art would be able to practice any of the embodiments described herein. Moreover, one of skill in the art could combine various embodiments described herein to provide further embodiments. The present invention is explained in more detail by the following example.

### Example

To illustrate the embodiments of the invention, and without limitation, the following exemplary example of a preparation of the edible nutrition system according to the disclosure is offered:

Firstly, a bag of dough is created by using a sphere shaped form. As a second step, the edible filling material (2) is filled in. In another step afterwards the edible or potable substance (3) is inserted, preferably in the form of a sphere and in a frozen condition.

The dough bag with the edible filling material (2), which additionally contains the edible or potable substance (3), is now closed by sealing the hole or opening of the dough and form one fixed unit during a baking process.

The baking process is preferably carried out in two steps.

Firstly, a certain part of the total baking time is elapsed, preferably about 75% of the total required baking time. After stopping the baking process at said certain level of the total baking time, the received product is frozen and thus prepared for storage or transportation.

The remaining baking time and thus the second baking step, preferably about 25% of the remaining baking time, is for example carried out at the place of serving.

Thereby, the pre-backed units are backed to the final degree by the second baking step. Both baking steps are carried out for example at 200° C. in a baking oven. The baking before serving generates a fresh and crisp outer-shell material or surface.

The preparation of the edible outer shell material (1) can be as follows:

The ingredients are for example:
400 g strong white bread flour, plus extra for dusting;
100 g fine ground semolina;
7 g sachets of dried yeast;
1 tablespoon honey;
100 g salted butter (at room temperature), plus extra for greasing;
¼ teaspoon onion powder;
¼ teaspoon garlic powder;
¼ teaspoon chili powder;
¼ teaspoon smoked paprika (regular paprika works fine, too);
350 ml water.

To make the dough, pile the flours and 1 teaspoon of fine sea salt on a clean surface and make a well in the centre. Add the yeast and sugar to 350 ml of lukewarm water, mix with a fork and leave it for a few minutes, and then gradually pour this mixture into said well. Using a fork, slowly bring in the flour from the inner edge of the well and mix into the water. Continue to mix, bringing in all the flour. When the dough comes together and becomes too hard to mix with your fork, dust your hands with flour and begin to pat it into a ball. Knead the dough, intensely, repeat this for about 10 minutes, or until you have a smooth, springy, soft dough.

Place the dough in a lightly greased bowl. Cover it with a piece of kitchen towel or cling film and leave it for about 45 minutes, or until it has doubled in size. Add the remaining ingredients such as spices and the butter, season to taste with sea salt and black pepper, then cover it with a damp tea towel and allow to prove once more for 20 minutes, or until the dough is slightly risen.

The preparation of the edible filing material (2) can be as follows:

The ingredients are for example:
150 gram smoked salmon;
200 gram cottage cheese;
1 gram calcium chloride or calcium lactate;
2 sprigs lemon thyme, leaves picked; and
Water.

Blitz the cottage cheese together with the lemon thyme leaves briefly in a food processor, adding very small amounts of water cautiously in case the cottage cheese is too sticky. Adding the smoked salmon, the calcium chloride and mix well until fine purée of high consistency is established.

For best results in next processing steps, the pH-value shall be measured and should be established well above 4,5. The mix shall not be refrigerated, but processed at room temperature. Exposure time at room temperature should be limited to production steps only. No storage at room temperature. Pour the purée into a receptacle with nozzles or a syringe that can produce drops of about 5 mm to 10 mm size.

The preparation of the edible or potable substance (3) can be as follows:

The ingredients are for example:
1 medium onion, peeled and quartered;
3 cloves garlic, peeled;
2 fresh red chilies, stalks removed;
olive oil;
herbs and spices;
10 sprigs fresh thyme or lemon thyme, leaves picked;
10 sprigs fresh rosemary, leaves picked;
5 bay leaves;
1 teaspoon cumin seeds;
1 tablespoon fennel seeds;
2 tablespoons smoked paprika; and
5 cloves.

For finish cooking:
2 oranges, zest and juice of;
1 lemon, juice of;
100 g honey;
100 g soft brown sugar;
6 tablespoons balsamic vinegar;
200 ml tomato ketchup;
1 tablespoons Worcestershire sauce;
2 teaspoons English mustard;
150 ml apple juice;
3 teaspoon calcium chloride or calcium lactate; and
1 teaspoon freshly ground black pepper.

In a first step the onion, chilies and garlic are blitzed together in a food processor until a really fine paste is established. This paste is fried in a pan with a lug of olive oil for 6 minutes at gentle heat.

In a second step all spices and herbs, including orange zest are processed in a food processor, until a homogenous mixture is achieved. This puréed mixture will be added to the pan and cooked together with the paste received from the first step for 2 more minutes. Cooking continues with adding the sugar, with continuous stirring, until it begins to dissolve and a thick brown paste is established. 270 ml of water, 150 ml of apple juice, the juice of 2 oranges and 1 lemon and 6 tablespoons of balsamic are added and cooking continues for another 3 more minutes. Finally by adding the remaining ingredients, the mix needs to be heat up to the boiling point, followed by simmering for about 7-15 minutes, until the mixture starts to thicken slightly.

Thereafter the sauce need to be purred through a fine sieve into a bowl to get rid of any larger bits left behind in the sieve. Leave the thus received product to cool completely to room temperature, but to not less than 18° C.

Pour sauce into a receptacle with nozzles that can produce drops of about 5 mm to 10 mm size.

Prepare an alginate bath, using 500 ml distilled water at temperature of 21-23° C. and add 6 gram sodium alginates. The mix must be high-speed stirred until the alginate is fully resolved. Before using the alginate bath, a rest time of min 5 hours is required to eliminate air bubbles from the stirring process.

The creation of spheres can be carried out as follows:

Place the nozzle just over the alginate bath and drop bubbles of 5-10 mm diameter of the sauce forming the edible or potable substance (3) into the bowl containing the alginate bath. The spherification process will take place immediately. Remove the droplets from the bath within 10 seconds with a sieve. Repeat the process to create an inventory of sauce droplets.

Use a syringe to drop bubbles of 5-10 mm diameter of the purée forming part of the inner filling material (2) into the bowl containing the alginate bath. Spherification process will take place immediately. Remove droplets from the bath within 10 seconds with a sieve. Repeat the process to create an inventory of filling droplets.

Divide the proved dough into 10 roughly equal size parts for easier processing. Take the dough onto a clean surface and roll it out, lightly flour surface before. Roll the dough out it is until 4 mm thin. Use a pizza cutter to cut 5×5 cm square sheets out of the dough. Push over a sphere shaped form with 3 cm diameter, until the dough becomes very thinned out in order to create little dough bags.

Place for any two spheres of edible filling material (2) one spheres of sauce (3). Typically the dough bag should contain 6 spheres: 2 filled with sauce (3) and 4 filled with edible filling material (2). Close the bags by drilling the dough together and remove the excess dough with a knife or scissor.

In order to create a perfectly round shaped edible nutrition system, the dough bags are packed into a metal backing form of the final desired shape, for example, a perfect bowl of 3 cm diameter. Dough expansion during the backing process will create a seamless ball shaped edible outer shell material (1), which also fills in any gap between the inserted sphere balls of (2) and (3).

Preheat the oven to 180° C., then bake for 10 to 12 minutes, or until pale golden. The dough balls are ready when they sound hollow when tapped on the base.

The invention has been described in detail with particular reference to certain preferred embodiments thereof, but it will be understood that variations and modifications can be effected within the spirit and scope of the invention.

1.-29. (canceled)

30. A method of preparing an edible nutrition system, comprising:
subjecting an edible or potable substance (3) to spherification to create a thermostable coating around the edible or potable substance (3);
providing an edible outer shell material (1) in form of a bag;
filling the bag of the edible outer shell material (1) with an edible filling material (2);
inserting the edible or potable substance (3) into the bag of the edible outer shell material (1);
closing the bag of the edible outer shell material (1) with further edible outer shell material (1);
placing the closed bag of the edible outer shell material (1) into a baking form; and
baking the edible nutrition system in one or more baking steps.

31. The method according to claim 30, wherein the edible or potable substance (3) is frozen during inserting the edible or potable substance (3) into the bag of the edible outer shell material (1).

32. The method according to claim 30, further comprising:
mixing the edible or potable substance (3) with the edible filling material (2) before inserting the mix thereof in the bag of outer shell material (1).

33. The method according to claim 30,
wherein the edible filling material (2) is provided in one or more compartments of the edible filling material (2) and
wherein the edible or potable substance (3) is provided in one or more compartments of the edible or potable substance (3).

34. The method according to claim 30,
wherein the thermostable coating is a thin jelly membrane.

35. The method as in claim 30,
wherein inserting the edible or potable substance (3) includes arranging the edible or potable substance (3) to form an innermost core of the edible nutrition system and to be completely encapsulated by the edible filling material (2).

36. The method as in claim 30, further comprising:
subjecting a further edible or potable substance (3) to spherification to create a further thermostable coating around the further edible or potable substance (3); and
inserting the further edible or potable substance (3) into the bag of the edible outer shell material (1).

37. The method as in claim 30,
wherein placing the closed bag of the edible outer shell material (1) into a baking form includes causing the edible nutrition system to be sphere-shaped, egg-shaped, or bubble-shaped.

38. The method as in claim 30,
wherein the edible or potable substance (3) comprises edible or potable particles, the edible or potable particles being selected from the group consisting of particles of a food, particles or natural fibers of a vegetable or powdered vegetable, particles of an energy supplement, particles of a dietary supplement, particles of a confection, particles of a nutraceutical, particles of a flavoring agent, particles of vitamins, mineral sweets, ice cream, yeast, oil, gas, chewing gum, caffeine, tea, coffee, cacao, milk, yoghurt, curd, pudding, cottage cheese, butter milk, and particles of a sweetener.

39. The method as in claim 30,
wherein subjecting the edible or potable substance (3) to spherification includes sieving the edible or potable substance (3);
placing the edible or potable substance (3) into a receptacle;
guiding the edible or potable substance (3) from the receptacle through a nozzle to generate droplets having a diameter of 5 to 10 mm;
dropping the droplets of the edible or potable substance (3) into an alginate bath; and
removing the droplets from the alginate bath.

40. The method as in claim 30,
wherein the edible or potable substance (3) is selected from the group consisting of fruit, meat, vegetable, nuts, a dairy product, an energy supplement, a confection, a nutraceutical, a powdered vegetable, a flavoring agent, a sweetener, and combinations thereof.

41. The method as in claim 30,
wherein the edible or potable substance (3) is sphere-shaped, egg-shaped or bubble-shaped.

42. The method as in claim 30,
wherein the edible or potable substance (3) has a diameter between 2 mm and 10 mm.

43. The method as in claim 30,
wherein the edible outer shell (1) further comprises one or more additive(s) selected from the group consisting of color agents, spices, herbs, seeds, baobab, salt, sugar, flour, parts or particles of plants, flowers, leaves, root fruits or fruit extracts, and flavor agents.

44. The method as in claim 30,
wherein the edible filing material (2) is selected from the group consisting of fruit, meat, vegetable, a dairy product, a carbohydrate food product, an energy supplement, a confection, a dietary supplement, a nutraceutical, a powdered vegetable, a flavoring agent, a sweetener, a powdered food product and combinations thereof.

45. The method as in claim 30,
wherein the edible filling material (2) has a thickness between 10 mm and 20 mm.

46. The method as in claim 30,
wherein the edible outer shell material (1) has a thickness between 2 mm and 5 mm.

47. The method as in claim 30, further comprising:
subjecting the edible filling material (2) to a spherification or reverse-spherification process to create a further thermostable coating around the edible filling material (2).

48. The method as in claim 47,
wherein the further thermostable coating prevents leaking of liquid out of the edible nutrition system during a baking process of the edible nutrition system.

49. The edible nutrition system prepared by the method as in claim 30.
